(19) United States
(12) Patent Application Publication
(10) Pub. No.: US 2016/0360080 A1
(43) Pub. Date: Dec. 8, 2016

(54) HIGH-ADMITTANCE LOCAL SUPPRESSION HIGHLIGHT IMAGING SYSTEM

(71) Applicant: NATIONAL CHUNG SHAN INSTITUTE OF SCIENCE AND TECHNOLOGY, Taoyuan City (TW)

(72) Inventors: CHAO-WEN LIANG, TAICHUNG CITY (TW); JHE-SYUAN LIN, NEW TAIPEI CITY (TW); SHIH-CHE CHIEN, HSINCHU CITY (TW)

(21) Appl. No.: 14/730,385

(22) Filed: Jun. 4, 2015

(51) Int. Cl. H04N 5/238; G02B 27/28; G02B 13/18; G02B 13/00; G02F 1/13; G02B 15/14

(52) U.S. Cl. CPC H04N 5/238; G02F 1/1313; G02B 15/14; G02B 13/18; G02B 13/0095; G02B 27/283

(57) ABSTRACT

A high-admittance local suppression highlight imaging system includes a first optical zoom lens having a plurality of lenses, inclusive of at least three aspheric lenses, to thereby function as an imaging system; a second optical zoom lens including a plurality of lenses symmetrically arranged to thereby function as a relay system; a polarizing beam splitter disposed between the first optical zoom lens and the second optical zoom lens; a LCoS disposed at an imaging point at an end of the first optical zoom lens; and a photosensitive component provided in form of a CCD or a CMOS and disposed at an imaging point at an end of the second optical zoom lens. Therefore, the imaging system features enhanced admittance of light, ensures that images captured during a nocturnal picture-taking process will be clear but not overexposed, and is applicable to nocturnal vehicle surveillance and the other safety detection systems.

### FIELD OF TECHNOLOGY

The present invention relates to high-admittance local suppression highlight imaging systems, and more particularly, to an imaging system which is based efficiently on microprojection light path technology, is structurally simple, incur low cost, features high luminous flux, and is advantageously characterized in that images will generally remain unblurred and are never overexposed even in the event of sudden admittance of highlight during a state of low-brightness illumination.

### BACKGROUND

Conventional surveillance camcorders are effective in identifying tortfeasors and criminals. Conventional light sensing components, such as CCD and CMOS, are subjected to a limit on their dynamic ranges and thus adapted to perform sampling, once and only once, on an image in its entirety during a picture-taking process; as a result, bright portions of the image are overexposed, whereas dark portions of the image are underexposed. As for a conventional nocturnal imaging system, an abrupt change in the brightness of an object-based light source, coupled with overly short dynamic ranges of the CCD or CMOS, not only leads to overexposure or underexposure of the images thus captured, but also brings about deterioration of the contrast of the images, not to mention that the images can be too vague to be discerned.

According to the prior art, highlight suppression is effected by digital signal processing (DSP) module technology with a view to optimizing optical projection and balancing light beams through attenuation of otherwise high brightness and augmentation of otherwise low brightness to meet special needs. The results of the sampling of a highlight portion of an image are processed with DSP, so as to adjust and allow the highlight portion of the image to fall within a normal range and thus reduce the difference between the image and the preceding image; this is achieved in four ways, namely backlight compensation (BLC), highlight inversion (HLI), secondary exposure expansion dynamic range (ExDR camera), and WDR broad dynamic range camera.

However, although the above conventional imaging systems manage to work in typical scenarios, they do not function well in the nighttime. Furthermore, the above conventional imaging systems are disadvantaged in that their optical systems have an overly large length and incur high cost. As a result, there is still room for improvement in the prior art.

### SUMMARY

In view of the aforesaid drawbacks of the prior art, it is an objective of the present invention to provide a high-admittance local suppression highlight imaging system which comprises a first optical zoom lens, a second optical zoom lens, a polarizing beam splitter (PBS), a photosensitive component and a liquid crystal on silicon (LCoS). The first optical zoom lens has a plurality of lenses, inclusive of at least three aspheric lenses, to thereby function as an imaging system. The second optical zoom lens comprises a plurality of lenses symmetrically arranged to thereby function as a relay system. The PBS is disposed between the first optical zoom lens and the second optical zoom lens. The LCoS is disposed at an imaging point at the end of the first optical zoom lens. The photosensitive component is provided in the form of a CCD or a CMOS and disposed at an imaging point at the end of the second optical zoom lens.

Therefore, images of the surroundings are projected to the LCoS through the first optical zoom lens, then corrected by hiding a portion of light beams, and eventually projected to the photosensitive component through the polarizing beam splitter and the second optical zoom lens, thereby increasing admittance of light of the imaging system in its entirety and ensuring that images captured during a nocturnal picture-taking process will be clear but not overexposed. Accordingly, the high-admittance local suppression highlight imaging system of the present invention is applicable to nocturnal vehicle surveillance and the other safety detection systems.

### BRIEF DESCRIPTION

Objectives, features, and advantages of the present invention are hereunder illustrated with specific embodiments in conjunction with the accompanying drawings, in which:

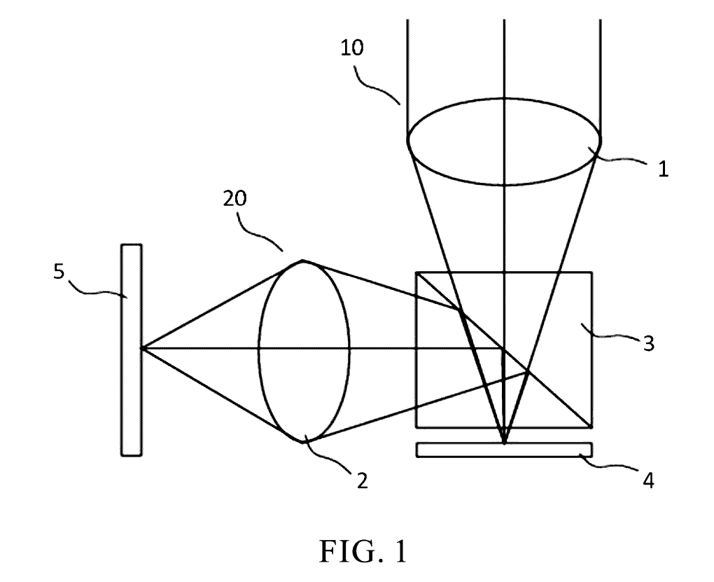

FIG. 1 is a schematic view of a high-admittance local suppression highlight imaging system of the present invention;

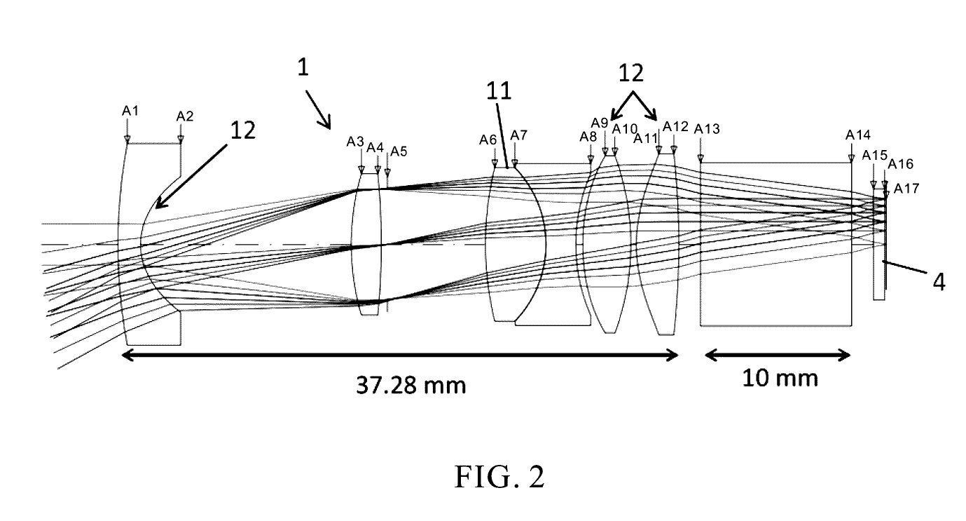

FIG. 2 is a schematic view of a light path of an imaging system operating in conjunction with a first optical zoom lens according to the present invention;

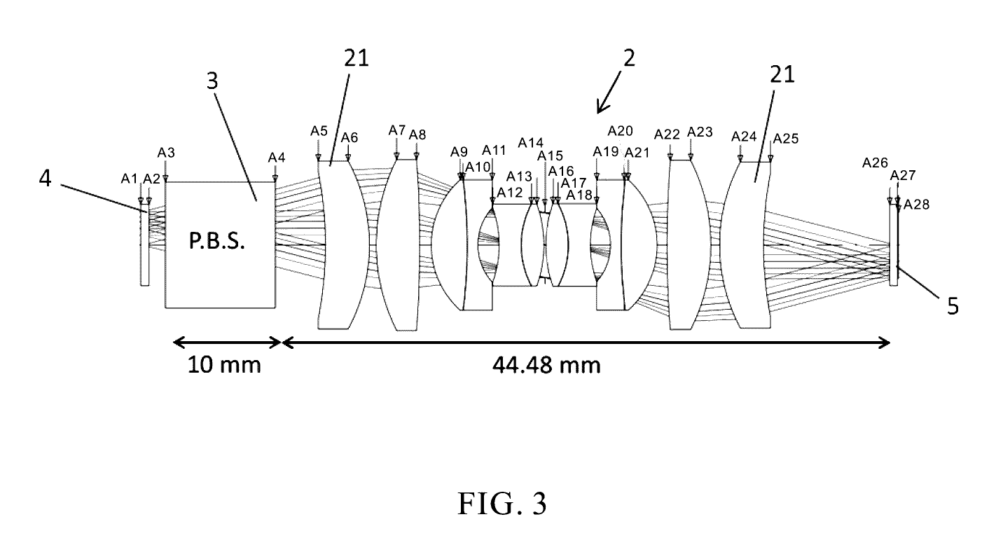

FIG. 3 is a schematic view of a light path of a relay system operating in conjunction with a second optical zoom lens according to the present invention; and

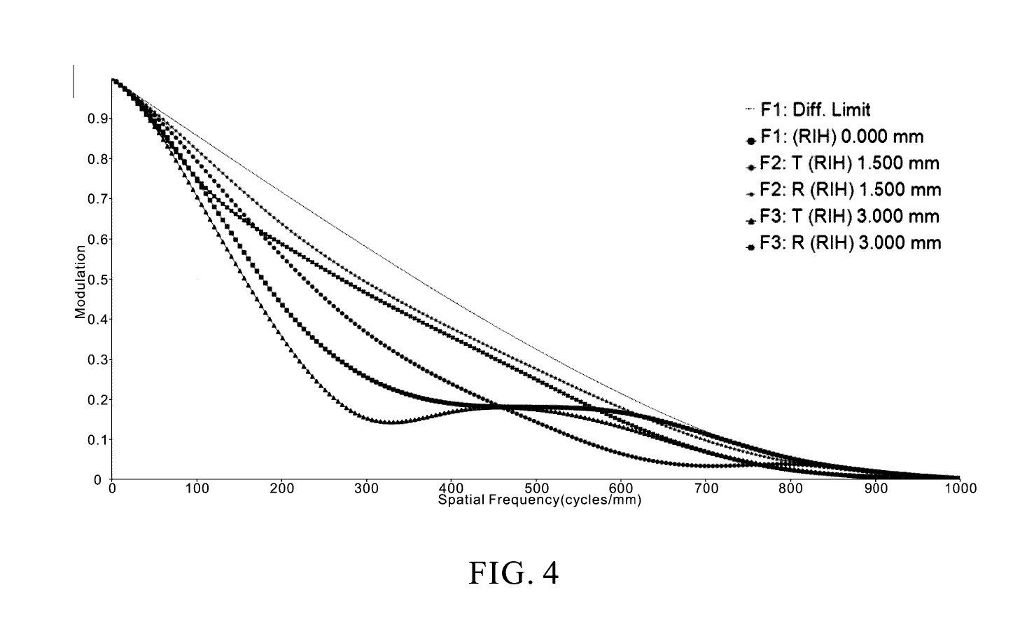

FIG. 4 shows graphs of data measured with MTF of the first optical zoom lens according to the present invention.

### DETAILED DESCRIPTION

Referring to FIGS. 1-3, the present invention provides a high-admittance local suppression highlight imaging system which comprises a first optical zoom lens 1, a second optical zoom lens 2, a polarizing beam splitter (PBS) 3, a photosensitive component 4 and a liquid crystal on silicon (LCoS) 5. The first optical zoom lens 1 has a plurality of lenses 11, inclusive of at least three aspheric lenses 12, to thereby function as an imaging system 10. The second optical zoom lens 2 comprises a plurality of lenses 21 symmetrically arranged to thereby function as a relay system 20. The PBS 3 is disposed between the first optical zoom lens 1 and the second optical zoom lens 2. The LCoS 4 is disposed at an imaging point at the end of the first optical zoom lens 1. The photosensitive component 5 is provided in the form of a CCD or a CMOS and disposed at an imaging point at the end of the second optical zoom lens 2.

Therefore, images of the surroundings are projected to the LCoS 4 through the first optical zoom lens 1, then corrected by hiding a portion of light beams, and eventually projected to the photosensitive component 5 through the PBS 3 and the second optical zoom lens 2, thereby increasing admittance of light of the imaging system in its entirety and ensuring that images captured during a nocturnal picture-taking process will be clear but not overexposed.

In an embodiment, the imaging system is a VGA 640×480 imaging system with a total length of 90 to 100 mm and a height of 75 to 80 mm. The first optical zoom lens 1 comprises six lenses 11 and has a length of 35 to 38 mm, with the optimal length of 37.28 mm. The second optical zoom lens 2 comprises 12 lenses and has a length of 42 to 50 mm, with the optimal length of 44.48 mm.

The system of the present invention is characterized by optical integration of the LCoS 4 and the photosensitive component 5 in a manner to exercise good control of distortion of images on the LCoS 4 and the photosensitive component 5 so as to optimize the matching of pixels.

The primary purpose of the imaging system 10 effectuated by the first optical zoom lens 1 is to allow images of the surroundings to fall on the LCoS 4. Since the optical system of the present invention requires very high admittance of light and is characterized of distortion of less than 1%, its optical specifications, such as f-number, FOV, and distortion, must be optimally configured; this, coupled with aspheric lenses, reduces the overall volume and distortion extent of the optical system of the present invention, thereby rendering it compact and practicable.

The relay system 20, which comprises the second optical zoom lens 2, must be configured to achieve the optimal matching of the pixels on the LCoS 4 and the photosensitive component 5 such that the images corrected by the LCoS 4 can fall accurately on the photosensitive component 5. In addition, the lenses of the second optical zoom lens 2 of the relay system 20 are symmetrically arranged to achieve optical magnification of 1, thereby rendering the optical system of the present invention compact and practicable.

Therefore, in an embodiment of the present invention, the specifications of the system of the present invention are as follows: CCD diagonal dimension of 6 mm, LCoS diagonal dimension of 6 mm, PBS lengthwise dimension of 10 mm, field of view (FOV) of 60°, a hyperfocal distance of 3 m, a focal length of 5.5 mm, relay system 20 optical magnification of 1, polymer wafer COC of 5 μm, and a f-number of 2.

Referring to FIG. 1 and FIG. 2, according to the present invention, the first optical zoom lens 1 comprises six lenses 11, inclusive of the three aspheric lenses 12 which are disposed on plane A2, plane A9 and plane All, respectively. The first optical zoom lens 1 is of a 3P4G structure (P denotes plastic, whereas G denotes glass.) Referring to FIG. 1 and FIG. 2, the three light beams have an angle of view of 0°, 21° and 30° (H=0, 0.7, 1), respectively. The imaging system 10 has a length of 37.28 mm approximately, a focal length of 5.5 mm, and a f-number of 2 to thereby effectuate high admittance of light of an optical system.

As shown in the light path diagram, a telecentric optical system is characterized in that the angle of incidence of the chief light beam onto the LCoS 4 approximates to 0° to thereby ensure that the incident light beam will reflect off the LCoS 4 and then travel to the PBS 3 to stay within the field of view of the PBS 3, thereby precluding vignetting.

Referring to FIG. 4, the system is configured to have its modulation transfer function (MTF) characterized in that the LCoS 4 exhibits 75 1p/frame of 0.2 at H=1. The present invention is characterized in that the first optical zoom lens 1 operates satisfactorily to keep a MTF greater than 0.5 at 150 1p/mm, i.e., at twofold cut-off frequency, when the LCoS 4 exhibits much higher MTF quality than required at 75 1p/mm as far as a conventional system is concerned.

Referring to FIG. 1 and FIG. 3, there are shown schematic views of light paths of light beams reflected off the LCoS 4 to fall on the PBS 3. FIG. 1 and FIG. 3 are illustrative, rather than restrictive, of the light paths. The relay system 20, which comprises the second optical zoom lens 2, has 12 lenses 21, inclusive of four doublet lenses. The relay system 20 is symmetrically structured to achieve optical magnification of 1 and a total length of less than 50 mm.

Referring to FIG. 3, the relay system 20, which comprises the second optical zoom lens 2, not only achieves a visual field angle of above 0.25 at 1.0 Field 75 1p/mm but also keeps a MTF greater than 0.5 at 150 1p/mm, i.e., at twofold cut-off frequency, thereby indicating that the relay system 20 meets the optimization requirement of the optical system.

The aforesaid optical design of the present invention is directed to a fixed focal length (FFL) system, applicable to a depth of field of 3 m to a point at infinity, a field of view FOV of 60 degrees or move, and a f-number of 2 and thus conducive to high admittance of light in a low-illumination environment. Upon admittance of highlight to a photosensitive component, such as CCD or CMOS, the optical system of the present invention attenuates the highlight instantly without compromising the frame quality or the brightness of the ambient images, thereby ensuring that the images will be clear but not overexposed.

In conclusion, the system of the present invention features microprojection light path design for use in monitoring photographic highlight suppression. On the contrary, the prior art which employs an algorithm or an electronic component to achieve highlight suppression. In addition, the present invention is advantageously characterized by a simple system framework, low cost, the practicability of simplifying an otherwise expensive sensing component in order to cut cost, and a sophisticated manufacturing process. Experimental findings show that the present invention is effective in achieving highlight suppression and features the processing of signals before the signals are received by a photosensitive component, such as a CCD or a CMOS, rather than resorts to conventional destructive correction.

Since security surveillance is becoming more sophisticated, highlight suppression is included in the functionality requirements of an increasing number of surveillance camcorders in order to boost the competitiveness thereof, especially when it comes to crime investigation and smart software backend processing. The present invention provides a new choice to meet the demand for highlight suppression technology in the broad dynamic photographic market and thus enhances the price competitiveness of products. Hence, the imaging system of the present invention is applicable to nocturnal vehicle surveillance and the other safety detection systems.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A high-admittance local suppression highlight imaging system, comprising:
a first optical zoom lens having a plurality of lenses, inclusive of at least three aspheric lenses, to thereby function as an imaging system;
a second optical zoom lens comprising a plurality of lenses symmetrically arranged to thereby function as a relay system;
a polarizing beam splitter disposed between the first optical zoom lens and the second optical zoom lens;
a LCoS disposed at an imaging point at an end of the first optical zoom lens; and
a photosensitive component provided in form of a CCD or a CMOS and disposed at an imaging point at an end of the second optical zoom lens,
wherein images of surroundings are projected to the LCoS through the first optical zoom lens, then corrected by hiding a portion of light beams, and eventually projected to the photosensitive component through the polarizing beam splitter and the second optical zoom lens.

2. The high-admittance local suppression highlight imaging system of claim 1, wherein the imaging system of the first optical zoom lens exhibits distortion of less than 1%, and the relay system of the second optical zoom lens has optical magnification of 1.

3. The high-admittance local suppression highlight imaging system of claim 2, wherein the imaging system is a VGA 640×480 imaging system with a total length of 90 to 100 mm and a height of 75 to 80 mm.

4. The high-admittance local suppression highlight imaging system of claim 2, wherein the first optical zoom lens has six lenses, inclusive of three aspheric lenses 12 which are disposed on plane A2, plane A9 and plane All, respectively, wherein the first optical zoom lens is a 3P4G design (P denotes plastic and G denotes glass.)

5. The high-admittance local suppression highlight imaging system of claim 2, wherein the first optical zoom lens has a focal length of 5.5 mm, a f-number of 2, field of view FOV of 60°, and a hyperfocal distance of 3 m.

6. The high-admittance local suppression highlight imaging system of claim 2, wherein the first optical zoom lens has a length of 35 to 38 mm.

7. The high-admittance local suppression highlight imaging system of claim 6, wherein the first optical zoom lens has a length of 37.28 mm.

8. The high-admittance local suppression highlight imaging system of claim 2, wherein the second optical zoom lens comprises 12 lenses and has a length of 42 to 50 mm.

9. The high-admittance local suppression highlight imaging system of claim 8, wherein the second optical zoom lens has a length of 44.48 mm.

10. The high-admittance local suppression highlight imaging system of claim 2, wherein the photosensitive component is a CCD and has a diagonal dimension of 6 mm, the LCOS has a diagonal dimension of 6 mm, the polarizing beam splitter has a lengthwise dimension of 10 mm, and polymer wafer COC of 5 μm.
